(19) United States
(12) Patent Application Publication
(10) Pub. No.: US 2013/0276339 A1
(43) Pub. Date: Oct. 24, 2013

(54) BEVERAGE BOTTLE IDENTIFICATION SYSTEM

(71) Applicants: Sean Lloyd Hernandez, Albertville, MN (US); Jill Marie Hernandez, Albertville, MN (US)

(72) Inventors: Sean Lloyd Hernandez, Albertville, MN (US); Jill Marie Hernandez, Albertville, MN (US)

(21) Appl. No.: 13/865,972

(22) Filed: Apr. 18, 2013

Related U.S. Application Data
(60) Provisional application No. 61/635,852, filed on Apr. 19, 2012.

(51) Int. Cl. G09F 3/02

(52) U.S. Cl. CPC G09F 3/02
USPC 40/311; 40/310

(57) ABSTRACT

A bottle identification topper is a flexible cap that can fit over the top of an existing bottle cap. The identification toppers may have different indicia, either imprinted thereupon, or attached thereto, to clearly identify a bottle, such as a beverage bottle, by its top. The bottle identification toppers may be provided in a box that may, for example, attach to the refrigerator and be readily available for users. The user can simply take one of the toppers, note the indicia it contains, attach the topper to the bottle cap, and they now know that this bottle belongs to them. The result is a simple, easy to use and fun bottle identification system.

### CROSS-REFERENCE TO RELATED APPLICATION

This application claims the benefit of priority of U.S. provisional application No. 61/635,852, filed Apr. 19, 2012, the contents of which are herein incorporated by reference.

### BACKGROUND OF THE INVENTION

The present invention relates to a beverage bottle identification system and, more particularly, to a reusable bottle cap toppers that are used to identify beverage bottles.

At a party or other get together, there are water bottles, pop bottles and other such bottles throughout the party location. No one knows whose bottle is whose because they all look the same. No one owns up to their water bottle and, before you know it, there are full and half full bottles everywhere.

Even without a party, simply around the home each day, there are water bottles on the counter, in the family minivan, in the fridge and people may not remember if it is their bottle or not. Without knowing for sure if the already used bottle belongs to them, they will get a new one and the partially used bottle goes to waste. People would rather not guess if it is their own bottle instead of simply getting a new one.

Bottled water, for example, can cost upwards to $2.00 per bottle, which figures out to about $10.00 per gallon. At these costs, it would be beneficial to find a way to keep track of ownership of beverage containers to reduce wasting those containers where there is uncertainty in ownership.

There have been other items which attempt to help identify water bottles, for example. These items typically have many parts and pieces and are often expensive to manufacture. Therefore, people haven't yet adopted a convenient system for tracking ownership of beverage containers. Some conventional products include a replacement cap that may be placed on the bottle. These replacement caps, however, may be in contact with the bottle's contents and may not be sanitary. People often choose bottled water for purity, but such conventional identifying bottle caps may reduce this desired purity.

As can be seen, there is a need for an improved system for tracking ownership and identity of beverage containers among multiple users.

### SUMMARY OF THE INVENTION

In one aspect of the present invention, a bottle identification system comprises a flexible material having a top surface and a side surface depending from the top surface; and an indicia disposed on at least an outer surface of the flexible material, wherein the indicia provides a unique identification for a bottle on which the bottle identification system is used.

In another aspect of the present invention, a bottle identification system comprises a flexible material having a top surface and a side surface depending from the top surface, the top surface and side surface forming a space for receiving a cap of a bottle; ridges formed on the side surface of the flexible material; and an indicia disposed on at least an outer surface of the flexible material, wherein the indicia provides a unique identification for a bottle on which the bottle identification system is used.

In a further aspect of the present invention, a method for identifying a bottle comprises placing a flexible material, having a top surface and a side surface depending from the top surface, on the bottle; and noting an indicia disposed on at least an outer surface of the flexible material, wherein the indicia provides a unique identification for the bottle.

These and other features, aspects and advantages of the present invention will become better understood with reference to the following drawings, description and claims.

### BRIEF DESCRIPTION OF THE DRAWINGS

FIG. 1 is a perspective view of a beverage bottle identification system, removed from a cap of a beverage container, according to an exemplary embodiment of the present invention;

FIG. 2 is a perspective view of a beverage bottle identification system, applied to a cap of a beverage container, according to an exemplary embodiment of the present invention;

FIG. 3 is a top perspective view of a flexible bottle cap topper used in the beverage bottle identification system of the present invention;

FIG. 4 is a underside perspective view of the flexible bottle cap topper of FIG. 3; and

FIG. 5 is a cross-sectional view taken along line 5-5 of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a bottle identification topper that is a flexible cap that can fit over the top of an existing bottle cap. The identification toppers may have different indicia, either imprinted thereupon, or attached thereto, to clearly identify a bottle, such as a beverage bottle, by its top. The bottle identification toppers may be provided in a box that may, for example, attach to the refrigerator and be readily available for users. The user can simply take one of the toppers, note the indicia it contains, attach the topper to the bottle cap, and they now know that this bottle belongs to them. The result is a simple, easy to use and fun bottle identification system.

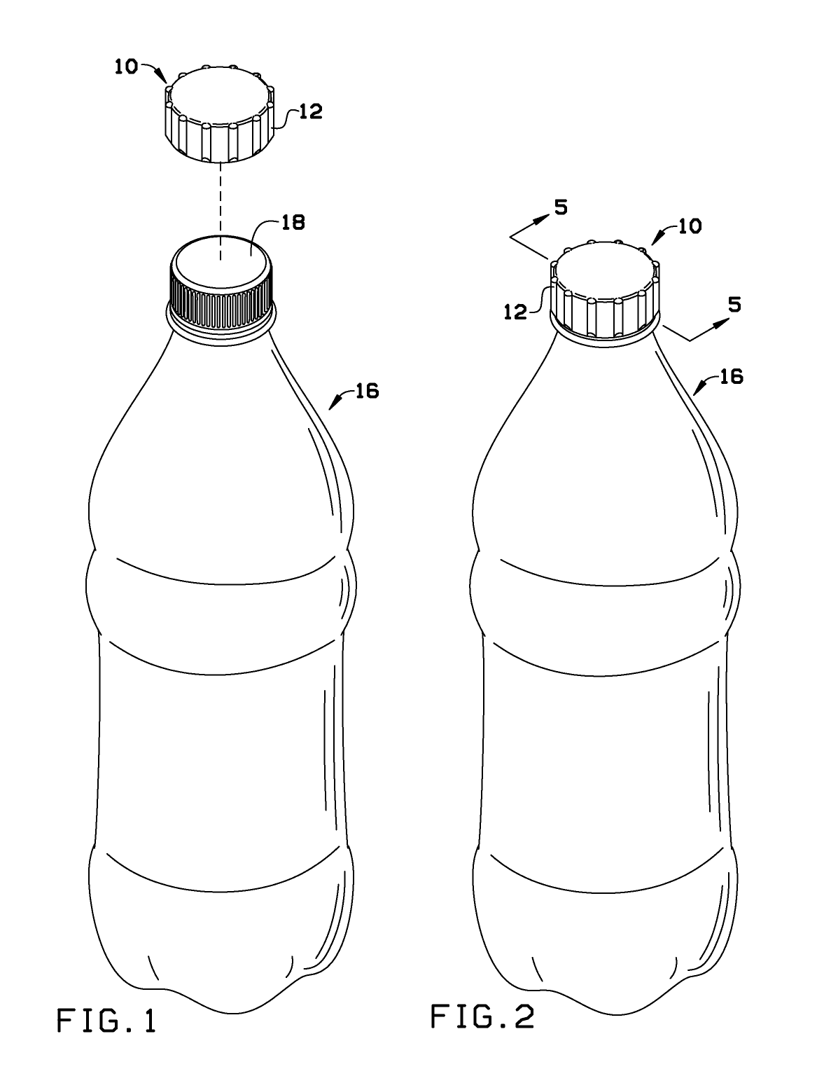

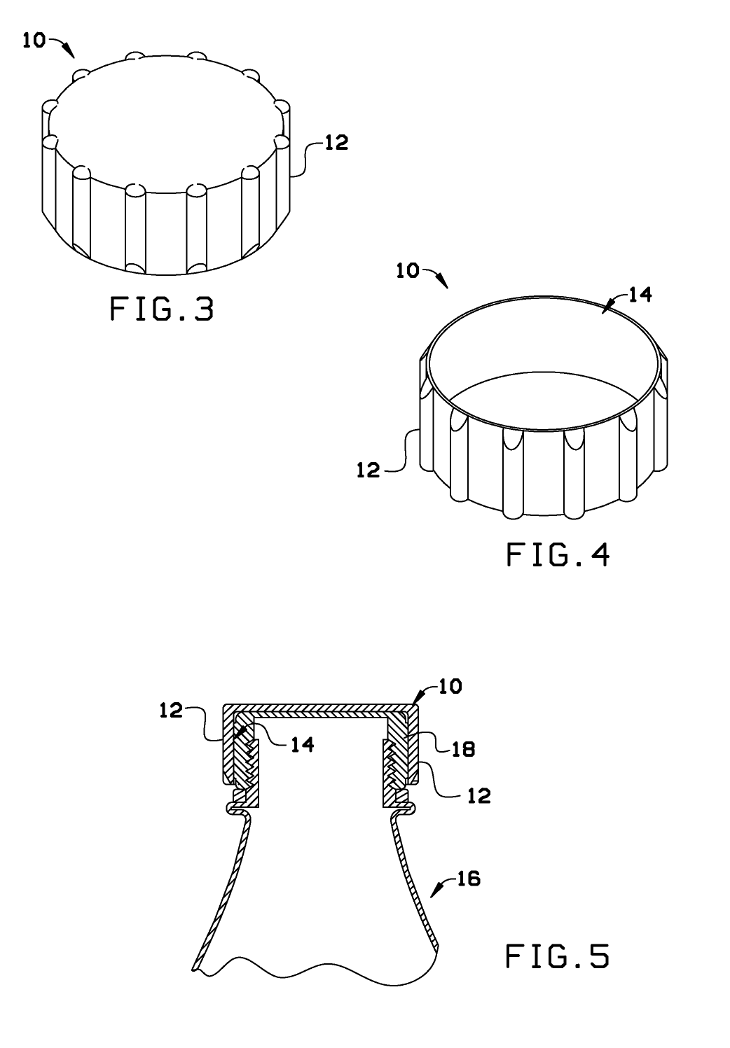

Referring to FIGS. 1 through 5, in an exemplary embodiment of the present invention, a bottle identification topper 10 may be made of a flexible, resilient material, such as rubber, silicon, neoprene, plastic or the like. The identification topper 10 may be adapted to have some stretch to permit attachment to a bottle cap 18, including those of various diameters or heights. An inner surface 14 of the identification topper 10 can contact a bottle cap 18 so that when the user turns the topper 10, the bottle cap 18 also turns and can be placed on the bottle or removed. The inner surface 14 can include a texture, such as ribs, notches, swirls, shingles, or the like, to provide improved contact between the inner surface 14 and the bottle cap 18.

The top surface, for example, of the bottle identification topper 10 may have one of a plurality of indicia printed thereupon. A user can simply remember their indicia to know which bottle 16 belongs to them. In some embodiments, the identification topper 10 can be formed in various colors, sparkles, glitter, tie die, glow in the dark, prints, swirls, scents, or the like, to identify one topper from another.

In some embodiments, a three-dimensional topper may be formed, where the indicia include one or more objects protruding from the identification topper 10. For example, troll-like hair may extend out of the top of the identification topper 10. This may be differently colored to provide further differentiation.

In some embodiments, an item may be attached to the top of the identification topper 10. For example, a sun or a flower top, may be attached to the top of the identification topper 10. Of course, other figurines, shapes, designs and objects may be used on the top of the identification topper 10.

In some embodiments, an item may be attached to the identification topper 10 via a flexible, spring-like attachment. Such a topper may be used to provide even more options for identifying a user's bottle.

In the above embodiments, the three-dimensional indicia may be formed integrally with the identification topper or may be removable and interchangeable with other designs.

In some embodiments, the identification topper 10 may include a ribbed perimeter 12 formed about the identification topper 10. This ribbed perimeter 12 may help a user in gripping the topper 10 and, in turn, gripping the bottle cap 18.

The identification topper 10 may be provided in various designs, as discussed above. In some embodiments, the designs may be centered about a particular theme. For example, a number of distinct toppers may be sold as a set about a Disney character theme which may be useful for a theme-based party or gathering. In some embodiment, toppers can be designed around a sporting team's colors, mascot, key player numbers, breast cancer ribbons, Holiday themes, famous persons, or the like. Of course, any number of theme and designs are contemplated within the scope of the present invention.

In some embodiments, the identification topper 10 can be designed with the top portion printed with advertising and/or logos. In some embodiments, the top portion can be printed with business information. Instead of a traditional business card, which many people throw away or stick in their wallets never to be seen again, office guests will now be given a bottle or water (or other beverage) and that a company's logo, contact information, salesperson's name, email, cell phone information, or the like, will be printed on the tops. The customer can take it home to be used over and over again. Various companies and hotels can use the identification toppers for their office customers and guests as well as for parades. Movie theaters can print their movie titles and movie characters on the tops to sell at the movie theater snack bar, for example.

In some embodiments of the present invention, a user can place an order for the identification topper, custom printed on the top with an image provide by the user. For example, a user can provide a photograph to be printed on the top of the identification topper. The photo may be the same for a plurality of toppers or a different photo can be provided for each topper. When the photo is the same on a plurality of toppers, they still may be different by the use of different colors, patterns, styles, or the like.

The identification toppers of the present invention could be useful in various settings, such as for daycares, child sports, nursing homes, and the like. The identification toppers can be used to help the elderly, children and carpel tunnel sufferers to help get those small caps off from their bottles. The identification toppers not only identify ownership of the bottles, but also act as a jar opener to get those small caps off and also replacement on the bottles.

In some embodiments, the identification toppers 10 may include a ring that attaches to the topper. The ring may be designed to fit around the top of the bottle so that if the identification topper is removed, it may still be secured to the bottle via the attached ring. The ring may attach to the identification topper via a connection mechanism, such as a flexible rubber or plastic connector, for example. Of course, other connection mechanisms may be contemplated within the scope of the present invention.

In some embodiments, a portion of the topper can be made of a magnetic material, allowing a user to store their individual topper on, for example, their refrigerator, when not in use.

In some embodiments, the identification toppers 10 may be used on directly carbonated beverage bottles, such as pop bottles. In this embodiment, the identification toppers may be designed with a vent to permit pressure to escape from the bottle through the topper. This design is especially useful in glass pop bottles where the original cap cannot be reused on the bottle, but a user still wishes to use a top to identify their bottle.

It should be understood, of course, that the foregoing relates to exemplary embodiments of the invention and that modifications may be made without departing from the spirit and scope of the invention as set forth in the following claims.

What is claimed is:

1. A bottle identification system comprising:
a flexible material having a top surface and a side surface depending from the top surface; and
an indicia disposed on at least an outer surface of the flexible material, wherein
the indicia provides a unique identification for a bottle on which the bottle identification system is used.

2. The bottle identification system of claim 1, wherein the flexible material fits over a cap of the bottle.

3. The bottle identification system of claim 1, further comprising ridges formed on the side surface of the flexible material.

4. The bottle identification system of claim 1, wherein the flexible material is a silicone-based material.

5. The bottle identification system of claim 1, wherein the indicia is selected from at least one of a color, a pattern, a shape, an image, an attached indicia attached to the flexible material, and a scent.

6. A bottle identification system comprising:
a flexible material having a top surface and a side surface depending from the top surface, the top surface and side surface forming a space for receiving a cap of a bottle;
ridges formed on the side surface of the flexible material; and
an indicia disposed on at least an outer surface of the flexible material, wherein
the indicia provides a unique identification for a bottle on which the bottle identification system is used.

7. The bottle identification system of claim 6, wherein the flexible material is a silicone-based material.

8. The bottle identification system of claim 6, wherein the indicia is selected from at least one of a color, a pattern, a shape, an image, an attached indicia attached to the flexible material, and a scent.

9. A method for identifying a bottle, comprising:
placing a flexible material, having a top surface and a side surface depending from the top surface, on the bottle; and
noting an indicia disposed on at least an outer surface of the flexible material, wherein
the indicia provides a unique identification for the bottle.
